(19) United States
(12) Patent Application Publication
(10) Pub. No.: US 2009/0225632 A1
(43) Pub. Date: Sep. 10, 2009

(54) Combination watch winder and display

(76) Inventor: Charles Agnoff, Wilmington, NC (US)

Correspondence Address: WILLIAM J. MASON;MACCORD MASON PLLC, POST OFFICE BOX 1489, WRIGHTSVILLE BEACH, NC, 28480, US

(21) Appl. No.: 12/074,947

(22) Filed: Mar. 7, 2008

(51) Int. Cl. G04B 5/00

(52) U.S. Cl. 368/207

(57) ABSTRACT

A device is described for use in winding self-winding watches that includes a case having a cavity for receiving a watch winder; and an electrically powered watch winder insertable in the case cavity. The watch winder has a first or display orientation and a second or winding orientation, and including a winding mechanism circuit with a tilt switch that is open when the winder is in the display orientation and closed when the winder is in the winding orientation. The winder may be oriented as a unit with, or independent of, the case. The winding mechanism may also include a manually operable on-off switch.

### BACKGROUND OF THE INVENTION

(1) Field of the Invention

The present invention relates to watch winders, and in particular to watch winders that have one orientation for display and another orientation for winding.

(2) Description of the Prior Art

Various mechanisms called watch winders have been designed to wind the main springs of self-winding watches when the watches are not being worn. Basically, these watch winders are comprised of a watch support to hold the watch at a desired orientation on the winder and a means for moving the watch support in a predetermined pattern, usually at periodic intervals. The movement pattern is preferably designed to simulate the movement of a user's wrist, thereby rotating or oscillating the watch in accordance with the watch's design to keep the main spring wound.

The winding mechanism of a self-winding watch is comprised of a bearing mounted pendulum or rotor that is connected through a gear reduction system to the mainspring of the watch. Generally, the rotor can rotate 360° in either direction. However, there are also so-called “hammer” shaped rotors in older self-winding watches that have a limited travel of 150° to 220° rotation. In either case when the watch is worn, the user's random and often rapid arm movements cause the rotor to swing back and forth inertially in both directions around the rotor axis, thereby winding the watch main spring. The watch main spring generally stores sufficient energy to keep the watch operating 36-48 hours, whether worn or not. Thus, when worn daily, the watch will be sufficiently wound to maintain continuous operation. However, if the watch is not worn regularly, the user must wind the watch, either manually or with a watch winder, or the watch will stop.

Watch winders are typically comprised of an electric drive mechanism that rotates a watch carrier adapted to hold a watch with the plane of the watch face perpendicular to the axis of rotation of the carrier. That is, the rotor axis is parallel to the axis of rotation of the drive mechanism, so that the watch rotates in the same plane as the hands of the watch. During the period of activation, the watch is partially or completely rotated several times either in a clockwise or counter-clockwise direction or, alternately, reversing in both directions. The powered rotation of the watch is controlled to limit the turns per day to prevent damage or malfunction due to the forces exerted on the winding mechanism.

The motor may be directly connected to the drive wheel by mounting the drive roller on the shaft of the motor, or the motor may be connected through intermediate gearing or belts. The motor in turn is connected in a circuit with a power source, e.g., a battery or other electric power supply, and a switch to open and close the circuit.

Watch winders are designed to operate with the face of the watch support, and thereby the face of the watch, oriented in a vertical plane or within less than 60° from vertical. When oriented in this manner, the rotor can freely rotate as the watch is rotated. This orientation is not desirable for the display of the watch winder or a watch mounted thereon, however, since the winder is normally at counter height when displayed, and thus below the potential purchasers line-of-sight. Thus, there is a need for a watch winder that serves the normal watch winding function, while being easily viewed by potential purchasers.

### SUMMARY OF THE INVENTION

Generally, the present invention relates to a watch winder that can be positioned in one of two orientations. In the first or display orientation, the winder is oriented to display the watch winder and any watch mounted thereon to potential purchasers. In the second or winding orientation the winder is operable to wind a watch supported on the watch winder. Importantly, the watch winder is operable only when it is in the second or winding orientation. The watch winder will normally be mounted in a case that can be oriented with the watch winder, or the watch winder can be oriented independent of the case orientation.

Watch winders forming a part of the present invention may be of different configurations, and the specific design of the winder, other than as specifically described herein, is not a feature of the present invention. Several watch winders and components thereof are described in the prior art, including in U.S. Pat. Nos. 6,254,270 and 6,543,929 to the present inventor, the entire content of these patents being incorporated herein by reference.

Normally, a suitable watch winder is comprised of a housing supporting a winder mechanism which includes a watch support that is rotatable mounted directly or through gearing to a rotatable shaft that is rotated by an electrical motor or other drive means. The drive means is in a circuit with a controller, which controls the frequency and interval of each activation of the winder mechanism. The watch support is often comprised of a compressible watch carrier that is inserted into a cup that is connected to the shaft.

The watch winder of the present invention is designed to be operable only when the winder is in the second or winding orientation, thereby avoiding unproductive rotation of the watch winder mechanism and watch when the winder is in the display orientation. For example, the mechanism's circuitry may include a position or tilt switch, e.g., a mercury switch or moveable ball switch, that is open when the winder is in the display orientation and closed when the winder is in the winding orientation, thereby enabling activation of the winding mechanism only in the winding orientation. Other mechanical or electrical means for effecting this result will become apparent to one skilled in the art.

Generally, the winder will be in the display, or inactive, orientation when the longitudinal axis of the winder mechanism shaft is at an angle of from about 0° to 30° relative to vertical, while the winder will be in the winding, or active, orientation when the longitudinal axis of the winder mechanism shaft is at an angle of from about 30° to 90° relative to vertical. When within this latter angular range, the tilt switch or other orientation-dependent switch will close, thereby completing the winding circuit.

The case in which the watch winder is mounted is generally in the shape of a lidded box with parallel front and back walls, parallel side walls extending between the ends of the front and back walls, a bottom wall extending to the edges of the front, back and side walls, and a lid hinged to the top edge of one of the side walls. The box walls define a cavity into which the watch winder is inserted. The lid, normally having a top wall and four side walls corresponding to the front, back and side walls of the box.

In one embodiment of the invention, the case is designed so that it can rest on either the bottom wall or one of the side walls.

The watch winder is sized to be inserted into the box cavity so that the upper surface of the winder is generally parallel to the upper edges of the front, back and side walls when the winder is fully inserted. When the winder is fully inserted into the case and the case rests on the bottom wall of the case, the winder will be in the display orientation.

The watch winder may be oriented to the winding orientation in one of two ways. First, the watch winder and case can be tilted as a unit to at least 30° for vertical. For example, the case can be oriented to rest on a side wall instead of the bottom wall, thereby orienting the longitudinal axis of the winder horizontally, i.e., 90° from vertical. In this orientation, the tilt switch is closed and the winder is activated in accordance with the controller schedule, so long as the on-off switch is in the “on” position.

Alternatively, the winder can be oriented to the winding position independent of the case. For example, the winder can be lifted from the case, rotated to an angle between 30° and 90° from vertical and placed back onto the case so that the case supports the winder. For this purpose, it is not necessary for the winder to be fully reinserted into the case.

In operation, the watch winder with a watch mounted thereon is placed in the case with the watch winder longitudinal axis, i.e., the longitudinal axis of the rotatable drive shaft, being less than 30° from vertical. In this orientation, the watch faces generally upward so that it can be easily viewed by prospective purchasers.

When the watch winder is to be used to wind a watch that is mounted on the winder, either in the showroom or by the purchaser, the watch winder is oriented to the winding position either by rotating the case with the winder inserted in the case so that the vertical axis of the case, i.e., the axis transverse to the bottom wall is at an angle of greater than 30° from vertical, or by removing the watch winder from the case and rotating the watch winder so that the watch winder vertical axis is greater than 30° beyond vertical. The winding circuit is then closed automatically by the tilt switch, thereby winding the watch in accordance with the sequence programmed into the controller.

### BRIEF DESCRIPTION OF THE DRAWINGS

FIG. 1 is a perspective view of a preferred embodiment of the invention with the winder and case in the display orientation.

FIG. 2 is a perspective view of a preferred embodiment of the invention with the winder and case oriented together to the winding orientation.

FIG. 3 is a perspective view of a preferred embodiment of the invention with the winder tilted to the winding orientation and the case remaining in the upright position.

FIG. 4 is a side view of a typical winding mechanism.

FIG. 5 is a schematic of a typical drive mechanism electrical circuit.

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

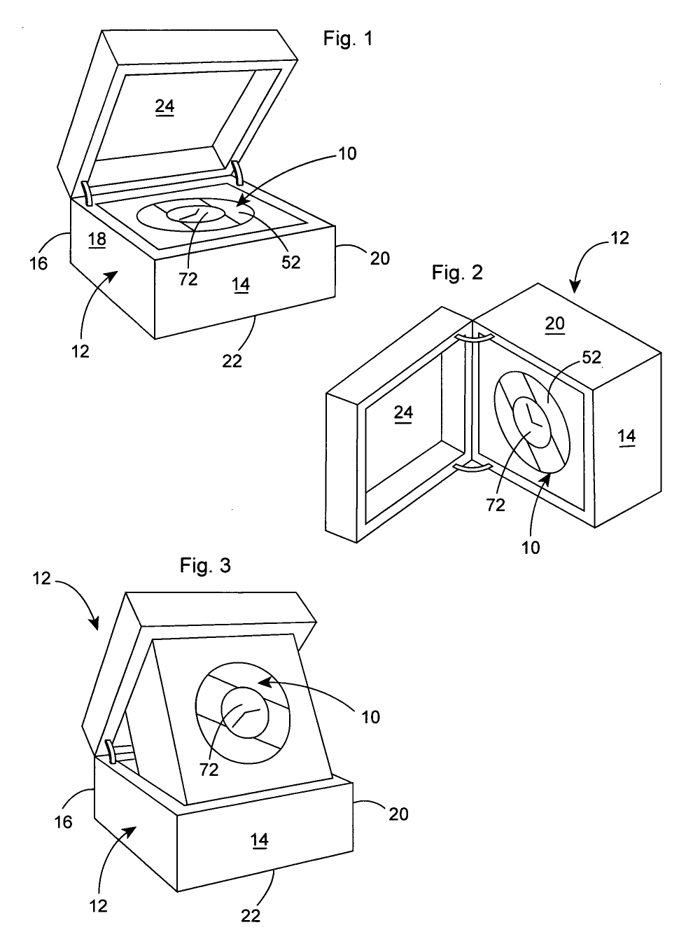

As best illustrated in FIGS. 1-3, the present invention is comprised of a watch winder, generally 10, that is mounted within a case, generally 12. Case 12 is generally in the shape of a lidded box with parallel front and back walls, 14 and 16 respectively, parallel side walls, 18 and 20 respectively, extending between the ends of walls 14 and 16, a bottom wall 22 extending to the lower edges of walls 14, 16, 18 and 20, and a lid 24 hinged to the top edge of one of the side walls. The box walls define a cavity into which watch winder 10 is inserted. In one embodiment of the invention, the case is designed so that it can rest on either wall 22 or one of side walls 14, 16, 18 or 20.

FIG. 1 illustrates winder 10 and case 12 in the first or display orientation with the longitudinal axis of winder 10 being oriented vertically, and case 12 being supported on bottom wall 22. In this orientation, watch 26 can be easily viewed while case 12 is setting on a counter, for example.

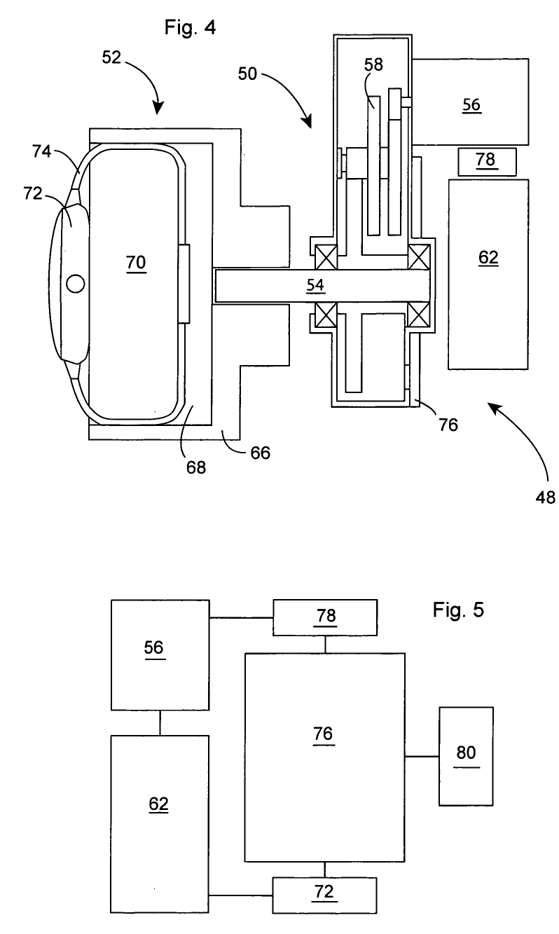

FIG. 2 illustrates watch winder 10 in the second or winding orientation with winder 10 and case 12 being tilted 90° so that case 12 is supported on side wall 22. In this orientation, the watch winder mechanism, generally 48 in FIG. 4, is operable to wind the watch.

FIG. 3 illustrates orientation of watch winder 10 in the second or winding orientation independent of case 12. In the embodiment illustrated, winder 10 is rotated approximately 45° from vertical independent of case 12 and then partially reinserted into case 12 with lid 24 further securing winder 10.

FIG. 4 illustrates a typical watch winder mechanism, generally 48, comprised of a drive mechanism, generally 50, and a watch carrier, generally 52. Drive mechanism 50 is comprised of a rotatable shaft 54 driven by electric motor 56 connected to shaft 54 through a set of reduction gears 58. Battery 62 powers motor 56. Watch carrier 52 is comprised of a molded cup 66 having an open cavity 68 to hold cushioned watch support 70, which is adapted to support a watch 72 with band 74 extending around watch support 70 when watch 72 is mounted on watch carrier 52. Battery 62 and motor 56 are in a circuit with controller 76 and tilt switch 78.

FIG. 5 illustrates the circuitry of drive mechanism 50, the circuitry being comprised of battery 62, motor 56, controller 76 and tilt switch 78. The circuitry also includes a manually operated on-off switch 80 to open and close the circuit to prevent operation of drive mechanism 48 when the winder is not to be used for extended periods.

In operation, watch 72 is mounted in carrier 52 on drive mechanism 48, which is within case 12. Case 12 is supported on bottom 22 for display of watch 72. When the vendor or the purchaser wishes to wind a watch, winder 10 and case 12 may be tilted as a unit onto side wall 18, positioning shaft 54 in a horizontal orientation and closing tilt switch 78. If on-off switch 80 is also closed, drive mechanism 50 is ready for activation as determined by controller 76. Upon activation, shaft 54 rotates carrier 52 thereby winding watch 72. Alternatively, as illustrated in FIG. 3, winder 10 can be tilted independently of case 12, and will operate in the same manner.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A watch winder for winding self-winding watches, said winder having first and second orientations, and being operable only when in said second orientation.

2. The watch winder of claim 1, having a circuit that includes an orientation-dependent switch having a closed position and an open position, said switch being in the open position when said winder is in the first orientation and in the closed position when said winder is in the second orientation.

3. The watch winder of claim 2, wherein said switch is a tilt switch.

4. The watch winder of claim 1, wherein said watch winder includes a rotatable shaft having a longitudinal axis that is less than 30° from vertical when said winder is in the first orientation.

5. The watch winder of claim 1, wherein said watch winder includes a rotatable shaft having a longitudinal axis that is between 30° and 90° from vertical when said winder is in the second orientation.

6. The watch winder of claim 1, further including an on-off switch.

7. The watch winder of claim 1, including a winder mechanism having a rotatable shaft, an electric motor to rotate said shaft, a watch carrier mounted on the end of said shaft, said watch carrier being adapted to support a watch with the watch face in a plane perpendicular to the longitudinal axis of said shaft.

8. A device for winding self-winding watches comprising:
a) a case; and
b) a watch winder insertable in said case, said winder having first and second orientations, and being operable only when in said second orientation.

9. The device of claim 8, wherein said case and winder are orientable as a unit between said first and second orientations.

10. The device of claim 8, wherein said winder is orientable between said first and second orientations independent of said case.

11. The device of claim 8, wherein said case has a hinged lid.

12. The device of claim 8, wherein said case has a bottom wall, a side wall and a winder-receiving cavity, said case being supportable or said bottom wall or said side wall.

13. The device of claim 12, wherein said side wall is at a 90° angle relative to said bottom wall.

14. The device of claim 12, wherein said watch winder includes a circuit with an orientation-dependent switch having a closed position and an open position, said switch being in the open position when said winder is in the first orientation and in the closed position when said winder is in the second orientation.

15. A device for winding self-winding watches comprising:
a) a case having a top wall, a bottom wall, at least one side wall, a hinged lid, and a cavity for receiving a watch winder; and
b) a watch winder insertable into said case cavity, said winder having a display orientation and a winding orientation, and including a winding mechanism circuit with a tilt switch having open and closed positions, said tilt switch being in the open position when said winder is in the display orientation and in the closed position when said winder is in the winding orientation.

16. The watch winder of claim 15, wherein said winding mechanism circuit also includes a manually operated on-off switch.

17. The watch winder of claim 15, wherein said winder mechanism includes a rotatable shaft oriented less that 30° from vertical when said winder is in the display orientation and from 30° to 90° from vertical when said winder is in the winding orientation, an electric motor to rotate said shaft, a watch carrier mounted on the end of said shaft to support a watch with the watch face in a plane perpendicular to the longitudinal axis of said shaft.

18. The device of claim 15, wherein said winder is moveable between said display and winding orientations as a unit with said case.

19. The device of claim 15, wherein said winder is moveable between said display and winding orientations independent of said case.

20. The device of claim 15, wherein said winding mechanism further includes a manually operable on-off switch.
